(19) United States
(12) Patent Application Publication
(10) Pub. No.: US 2024/0412915 A1
(43) Pub. Date: Dec. 12, 2024

(54) PRESSURE COMPENSATED COOLING RADIATOR FOR SUBSEA POWER EQUIPMENT

(71) Applicant: OneSubsea IP UK Limited, London (GB)

(72) Inventors: Audun Magne Askeland, Bergen (NO); Arill S. Hagland, Sandsli (NO); Anders Brunvold, Bergen (NO); Nils-Egil Kangas, Radal (NO); Stig Kaare Kanstad, Fana (NO); Kyrre Groenstoel, Nesttun (NO); Jarle Odegaard, Sandsli (NO)

(21) Appl. No.: 18/741,482

(22) Filed: Jun. 12, 2024

Related U.S. Application Data
(60) Provisional application No. 63/507,599, filed on Jun. 12, 2023.

(51) Int. Cl. H01F 27/08; F28D 1/02; F28F 3/12; H01F 38/00

(52) U.S. Cl. CPC H01F 27/08; F28D 1/022; F28F 3/12; H01F 38/00; F28F 2255/02

(57) ABSTRACT

A system includes a subsea transformer station and a heat exchanger fluidly coupled to the subsea transformer station. The heat exchanger is configured to diffuse thermal energy from the subsea transformer station. A portion of the heat exchanger is configured to receive a fluid from the subsea transformer station. The portion of the heat exchanger is also configured to expand, contract, or a combination thereof in response to variations of a pressure of the fluid, a temperature of the fluid, or a combination thereof.

### CROSS-REFERENCE TO RELATED APPLICATION

This application claims priority to and the benefit of U.S. Provisional Patent Application Ser. No. 63/507,599, entitled “Pressure Compensated Cooling Radiator for Subsea Power Equipment,” filed Jun. 12, 2023, which is hereby incorporated by reference in its entirety for all purposes.

### BACKGROUND

The subject matter disclosed herein relates to a heat exchanger for a subsea station.

For subsea applications, operation of a resource extraction system to extract the hydrocarbon fluid from a reservoir may consume energy, such as electrical energy. This electrical energy may come from various and multiple sources and locations and be generated a number of different ways. The various forms of energy are usually channeled to a power station having transformers to step the voltage up or down. In this process there are losses generated that result in a portion of thermal energy that must be managed to stay within system components tolerance. The transformers may be cooled via a coolant, where coolant may expand in volume and/or increase in pressure as an effect of temperature variation. Currently, methods of compensating for volume and pressure of the coolant fluid is complicated, and quality assurance is difficult. It would thus be helpful to be able to provide a system capable of both cooling and volumetric expansion.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In an embodiment, system includes a subsea transformer station and a heat exchanger fluidly coupled to the subsea transformer station. The heat exchanger is configured to diffuse thermal energy from the subsea transformer station. A portion of the heat exchanger is configured to receive a fluid from the subsea transformer station. The portion of the heat exchanger is also configured to expand, contract, or a combination thereof in response to variations of a pressure of the fluid, a temperature of the fluid, or a combination thereof.

In another embodiment, a system includes a heat exchanger configured to fluidly couple to a subsea transformer station. The heat exchanger is also configured to diffuse thermal energy from the subsea transformer station. A portion of the heat exchanger is configured to at least partially expand, contract, or a combination thereof in response to variations of a pressure, a temperature, or a combination thereof of a fluid disposed within the subsea transformer station.

In another embodiment, a method includes transferring a fluid from a subsea transformer station to a heat exchanger. The method also includes diffusing thermal energy from the fluid in response to the fluid flowing through the heat exchanger. The method also includes returning thermal energy depleted fluid from the heat exchanger to the subsea transformer station. The method also includes expanding a portion of the heat exchanger in response to an increase in a pressure of the fluid.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an embodiment of an offshore wind farm system having a subsea station;

FIG. 2 is a perspective view of an embodiment of the subsea station of FIG. 1 with a heat exchanger;

FIG. 3 is a perspective view of an embodiment of the subsea station and the heat exchanger of FIG. 2;

FIG. 4 is a schematic cross-sectional side view of an embodiment of the subsea station and the heat exchanger of FIG. 2;

FIG. 5 is a partially cutaway perspective view of an embodiment of the heat exchanger of FIG. 2 within an area identified by line 5-5;

FIG. 6 is a partially cutaway perspective view of an embodiment of the heat exchanger of FIG. 2 within an area identified by line 5-5 having a curved side wall;

FIG. 7 is a perspective view of an embodiment of a panel of the heat exchanger of FIG. 2 in an exaggerated expanded state;

FIG. 8 is a partially cutaway perspective view of an embodiment of the panel of FIG. 7 in a contracted state;

FIG. 9 is a side cross-sectional view of an embodiment of one or more panels of the heat exchanger of FIG. 2 having expandable side walls;

FIG. 10 is a side cross-sectional view of an embodiment of a panel of the one or more panels of FIG. 9 taken along line 10-10; and

FIG. 11 is schematic perspective view of the subsea station of FIG. 1 and the heat exchanger of FIG. 2.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are used in an open-ended fashion, and thus should be interpreted to mean “including, but not limited to.” Also, any use of any form of the terms “connect,” “engage,” “couple,” “attach,” or any other term describing an interaction between elements is intended to mean either an indirect or a direct interaction between the elements described. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. The use of “top,” “bottom,” “above,” “below,” and variations of these terms is made for convenience but does not require any particular orientation of the components.

As described in greater detail below, the disclosed embodiments include a heat exchanger that couples to a subsea station (e.g., subsea transformer station and/or specific subsea equipment). For example, the heat exchanger may be used with a subsea transformer, power distribution equipment, controllers or control systems, pumps, compressors, electric motors and actuators, electrical generators, valves, fluid manifolds, monitoring systems, or any subsea equipment that may be housed within an enclosure or tank, and wherein heat is generated and causes thermal expansion of the fluid inside the enclosure. Thus, any discussion of the subsea station may include any one or more of the subsea components that benefit from a heat exchanger. The heat exchanger is configured to both diffuse thermal energy from the subsea station, and also provide for volumetric expansion of a fluid (e.g., coolant, insulating fluid, dielectric fluid, etc.) disposed inside the subsea station. In one embodiment, the heat exchanger is a heat exchanger system including one or more panels. The one or more panels include channels through which the fluid can flow during volumetric expansion. Additionally, the side walls of the panels may expand in response to variations in pressure, temperature, or both, of the fluid. In certain embodiments, the side walls of the panels are coupled via expandable side walls that expand (unfold) in an accordion-like manner in response to variations in the pressure, the temperature, or both of the fluid. In certain embodiments, the panels are integrally formed into the subsea station and provide cooling to the subsea substation via a plurality of channels that extend through the panels, enabling a surrounding fluid (e.g., sea water) to pass through the panels and thereby cool the subsea station.

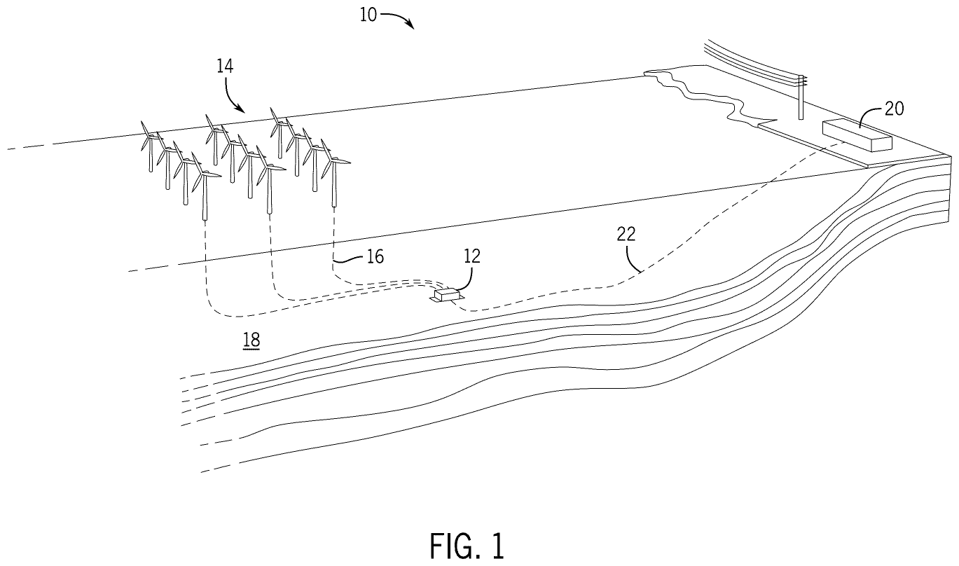

With the foregoing in mind, FIG. 1 is a diagrammatical view of an embodiment of an offshore wind farm system 10 having a subsea station 12. As shown, the offshore wind farm system 10 includes offshore wind turbines 14. The offshore wind turbines 14 are electrically coupled via electrical cables 16 (e.g., umbilical cables) used for transmitting electrical power and/or information from the offshore wind turbines 14 to the subsea station 12, which is disposed on a sea floor 18. As shown, the subsea station 12 transmits electrical power and/or information to an onshore power station 20 via an electrical cable 22 (e.g., export cable). Although the illustrated embodiment shows one subsea station 12, the offshore wind farm system 10 may include multiple subsea stations 12 that reside on the sea floor 18 that are electrically coupled to the offshore wind turbines 14 and/or the onshore power station 20. In certain embodiments, as discussed herein, the subsea station 12 includes a subsea transformer configured to step up a voltage of the power generated by the offshore wind turbines 14.

It may be appreciated that the subsea station 12 may be used for other subsea applications. In certain embodiments, the subsea station 12 may belong to a subsea hydrocarbon extraction system, a subsea geothermal system, a subsea injection system (e.g., subsea gas injection system, subsea water injection system), or a combination thereof. Additionally or alternatively, the subsea station 12 may include various types of subsea equipment. For example, the subsea station 12 may include a pump station, a power station, a manifold, a tree, a control station, power electronics, batteries, computers, motors, or a combination thereof.

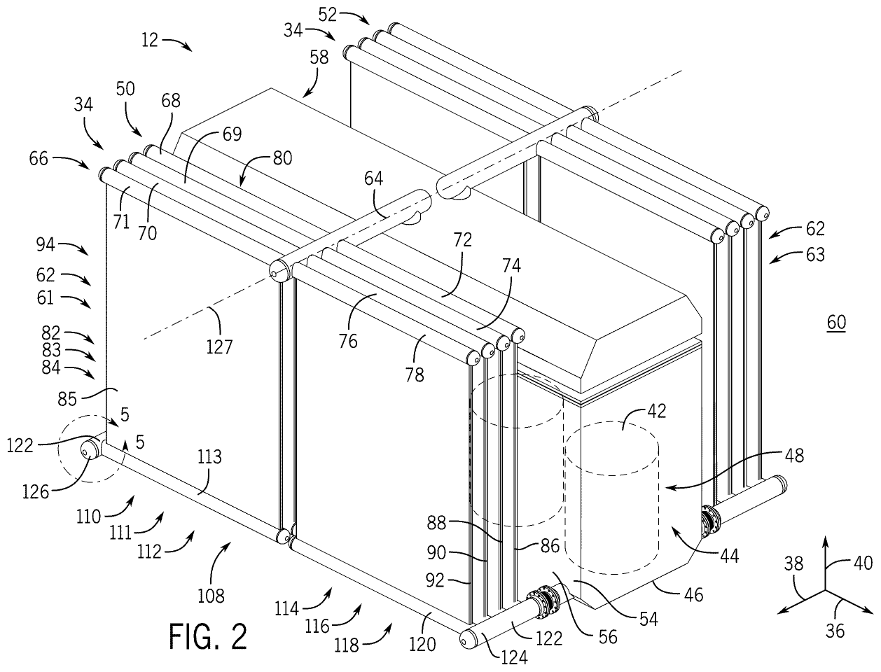

FIG. 2 is a perspective view of an embodiment of the subsea station 12 of FIG. 1 with a heat exchanger 34. The subsea station 12 and the heat exchanger 34 are described herein in relation to a longitudinal direction or axis 36, a lateral direction or axis 38, and a vertical direction or axis 40. As shown, the subsea station 12 (e.g., subsea transformer station) includes one or more transformers 42 disposed in an interior 44 of a housing 46 (e.g., tank, transformer tank). Additionally, the subsea station 12 includes an insulating fluid 48 (e.g., insulating oil, dielectric fluid, or transformer oil) disposed in the interior 44 of the housing 46. In certain embodiments, the insulating fluid 48 may include a gaseous fluid. The subsea station 12 includes heat exchangers 40 (e.g., heat exchangers 50, 52) that are disposed exterior to the housing 46, and substantially parallel to sidewalls 54 (e.g., sidewalls 56, 58) of the housing 46. The subsea station 12 also has high pressure fluid flow connections or penetrators to provide more flexibility to the steel thickness.

In certain embodiments, the transformers 42 may be hermetically sealed via the housing 46 to isolate the transformers 42 from the water 60. In certain embodiments, the one or more transformers 42 may each have a power rating of at least 100, 200, 300, 400, or 500 megavolt amperes (MVA). The insulating fluid 48 is configured to at least partially dissipate the thermal energy generated by the transformers 42. In certain embodiments, the transformers 42 may use at least 100, 200, 300, 400, 500, 600, 700, or 800 kilowatts (kW) of power for cooling. In response to being heated by the transformers 42, the insulating fluid 48 volumetrically expands. In certain embodiments, the insulating fluid 48 may expand by at least 1, 2, 3, 4, 5, 6, 7, 8, or 9 cubic meters (m3). As disclosed herein, the heat exchanger 34 is configured to diffuse thermal energy (e.g., heat) from the subsea station 12 and provide volumetric compensation for the expansion of the insulating fluid 48 by receiving a portion of the insulating fluid 48.

In the illustrated embodiment, the heat exchanger 34 includes a heat exchanger system 62 (ec.g., heat exchanger systems 61, 63). As shown, the heat exchanger system 62 (e.g., radiator system) includes an inlet conduit 64 fluidly coupled to the interior 44 of the housing 46, a plurality of diverging conduits 66 (e.g., diverging conduits 68, 69, 70, 71, 72, 74, 76, and 78) that diverge from the inlet conduit 64, one or more panels 80 (e.g., panels 82, 83, 84, 85, 86, 88, 90, and 92) having channels 94 enclosed in the one or more panels 80 (e.g., expandable panels) and fluidly coupled to the diverging conduits 66, a plurality of converging conduits 108 (e.g., converging conduits 110, 111, 112, 113, 114, 116, 118, 120) fluidly coupled to the one or more panels 80, and outlet conduits 122 (e.g., outlet conduits 124, 126) fluidly coupled to the converging conduits 108 as well as to the interior 44 of the housing 46. As shown in the illustrated embodiment, the heat exchanger system 63 includes a substantially equivalent structure to that of the heat exchanger system 61.

Although the illustrated embodiment shows the inlet conduit 64 and the outlet conduits 122 as being symmetrical relative to a lateral central axis 127 of the heat exchanger 34, in certain embodiments the inlet conduit 64 and/or the outlet conduits 122 may be offset. Additionally or alternatively, in certain embodiments, the heat exchanger 34 may include more than one inlet conduit 64. For example, the heat exchanger 34 may include 2, 3, 4, or more inlet conduits 64. Additionally or alternatively, the heat exchanger 34 may include fewer or more than two outlet conduits 122. For example, the heat exchanger 34 may include 1, 3, 4, 5, or more outlet conduits 122.

In response to an expansion of the insulating fluid 48, the inlet conduit 64 receives a portion of the insulating fluid 48 from the interior 44 of the housing 46 of the subsea station 12. The insulating fluid 48 flows through the inlet conduit 64, the diverging conduits 66, the one or more panels 80 (e.g., via the channels 94), the converging conduits 108, and the outlet conduits 122, and is circulated back to the interior 44 of the housing 46. As the insulating fluid 48 flows through the heat exchanger system 62, the insulating fluid 48 is exposed to additional surface area provided by the one or more panels 80. The heated insulating fluid 48 is cooled as it travels through the one or more panels 80, such that the insulating fluid 48 that is recirculated back to the housing 46 is cooler than the insulating fluid 48 that is received by the heat exchanger system 62 from the housing 46. The cooled fluid has higher density than the hotter fluid, thus driving the flow of fluid through the heat exchanger system by gravity force (e.g., natural convection). In particular, the one or more panels 80 of the heat exchanger system 62 transfer heat away from the insulating fluid 48 into water 60 surrounding the heat exchanger system 62. As discussed in further detail herein, in certain embodiments, a portion of the heat exchanger system 62 is configured to expand, contract, or a combination thereof in response to variations of a pressure, a temperature, or a combination thereof, of the insulating fluid 48.

Colder fluid has higher density and sinks to the bottom while hotter fluid has lower density and gets updrift in a natural convection cooler. Thus, to further aid in cooling, the inlet conduit 64 for the insulating fluid 48 may be disposed as high as possible while the outlet conduit(s) 122 may be disposed as low as possible.

Although the illustrated embodiment shows six panels 80 in each heat exchanger system 62, in certain embodiments each heat exchanger system 62 may have fewer or more than six panels 80. For example, the heat exchanger system 62 may include 1, 2, 3, 4, 5, 7, 8, or more panels 80. Additionally or alternatively, although the illustrated embodiment shows two heat exchanger systems 62 coupled to the subsea station 12, in certain embodiments, fewer or more than two heat exchanger systems 62 may be coupled to the subsea station 12. For example, 1, 3, 4, 5, or more heat exchanger systems 62 may be coupled to the subsea station 12 on the sides and/or top of the subsea station 12.

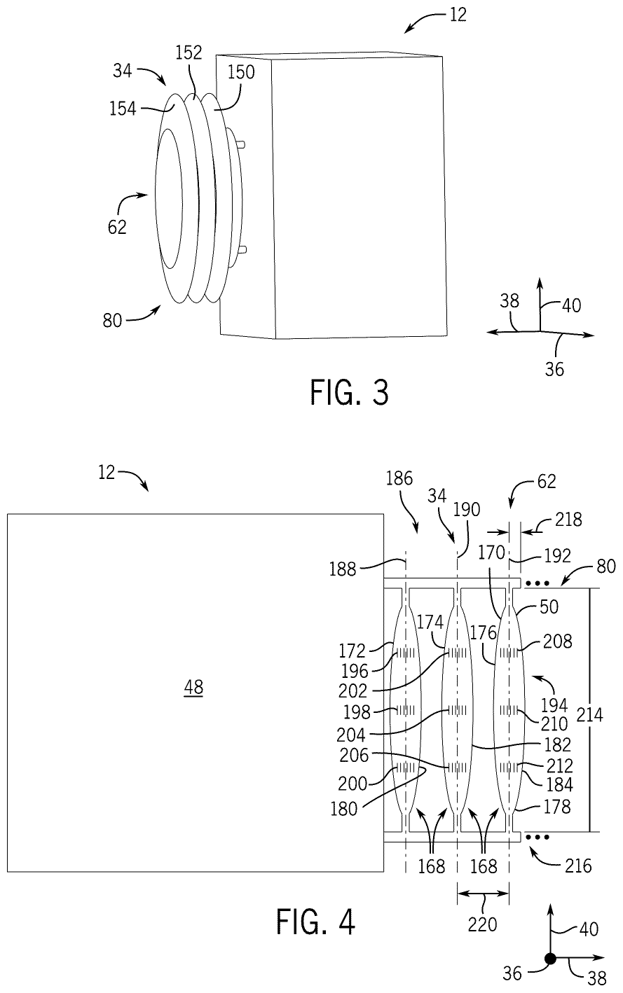

FIG. 3 is a perspective view of an embodiment of the subsea station 12 and the heat exchanger 34 of FIGS. 1 and 2. In the illustrated embodiment, the heat exchanger 34 includes the heat exchanger system 62 having the one or more panels 80 (e.g., panels 150, 152, 154). As shown in the illustrated embodiment, the one or more panels 80 are circular in shape (e.g., as opposed to being rectangular in shape). In certain embodiments, the one or more panels 80 may be elliptical in shape, oval in shape, or generally rounded in shape. In certain embodiments, the one or more panels 80 may include beveled corners. It may be appreciated that the circular shape of the one or more panels 80 may reduce an amount (e.g., level) of stress experienced by the one or more panels 80. Although the illustrated embodiment shows the heat exchanger system 62 as having three panels 80, in certain embodiments the heat exchanger system 62 may have more or fewer than three panels 80. As discussed in further detail below, the one or more panels 80 are configured to expand and contract in response to changes in temperature and pressure of the insulating fluid 48.

FIG. 4 is a schematic cross-sectional side view of an embodiment of the subsea station 12 and the heat exchanger 34 of FIGS. 1 and 2. As shown, the heat exchanger 34 includes the heat exchanger system 62 having the one or more panels 80. In the illustrated embodiment, each of the one or more panels 80 includes side walls 168 including an inner side wall 170 (e.g., inner side walls 172, 174, and 176) and an outer side wall 178 (e.g., outer side wall 180, 182, and 184).

As shown, the inner side wall 170 and the outer side wall 178 are configured to integrally bulge (e.g., bow, curve, expand) outward relative to a central axis 186 (e.g., central axis 188, 190, and 192) of the panels 80 in response to an increase in a pressure of the insulating fluid 48, an increase in a temperature of the insulating fluid 48, or a combination thereof. In the illustrated embodiment, both the inner side walls 170 and the outer side walls 178 expand in response to the variations in the pressure of the insulating fluid 48, the temperature of the insulating fluid 48, or a combination thereof. In certain embodiments, the inner side walls 170 and/or the outer side walls 178 may expand outward relative to the central axis 186 or may contract inward relative to the central axis 186 in response to the variations in the pressure of the insulating fluid 48, the temperature of the insulating fluid 48, or a combination thereof. In certain embodiments, the inner side wall 170 and/or the outer side wall 178 may be composed of steel (e.g., stainless steel, cathodic-protected carbon steel, etc.). In certain embodiments, the inner side walls 170 and/or the outer side walls 178 may have a radius of curvature of at least 10 m, 20 m, 30 m, 40 m, 60 m, 80 m, or 100 m when the inner side walls 170 and/or the outer side walls expand or contract relative to the central axis 186.

In the illustrated embodiment, the one or more panels 80 each include one or more support structures 194 (e.g., support structures 196, 198, 200, 202, 204, 206, 208, 210, 212) disposed between the inner side wall 170 and the outer side wall 178 of the one or more panels 80. In certain embodiments, the one or more support structures 194 (e.g., internal supports, perforated supports, etc.) may be configured to separate the inner wall 170 (e.g., first side wall) and the outer side wall 178 in response to a vacuum being applied to the channel 94 disposed between the inner side wall 170 and the outer side wall 178. In certain embodiments, the one or more support structures 194 may remain coupled to both the inner side wall 170 and the outer side wall 178 during an expansion of the inner side wall 170 and/or the outer side wall 178. In certain embodiments, the one or more support structures 194 may include expandable and contractable supports, such as foldable and unfoldable metal plates (e.g., zigzagging metal plates or metal bellows), piston-cylinder assemblies, metal straps, or any combination thereof. In other words, the one or more support structures 194 may provide an expansion limit to enable expansion while limiting the overall expansion to avoid damage of the one or more panels 80. Although the illustrated embodiment shows each panel 80 having three support structures 194, in certain embodiments the one or more panels 80 may have fewer or more than three support structures 194. For example, each of the one or more panels 80 may include 1, 2, 4, 5, 6 or more support structures 194.

In the illustrated embodiment, the one or more panels 80 include a length 214 and a width 216. The length 214 and/or the width 216 of the one or more panels 80 may be greater than 1 meter, 2 meters, 3 meters, 4 meters, 5 meters, or 6 meters. In certain embodiments, the length 214 and/or the width 216 may range from 3 meters to 6 meters. As shown, the sidewalls 168 may expand (e.g., bulge, bow, etc.) an expansion distance 218 outward relative to the central axes 186 of the one or more panels 80. In certain embodiments, the expansion distance 218 may be more than 5 millimeters (mm), 10 mm, 20 mm, 40 mm, or 70 mm. In certain embodiments, the expansion distance 218 may range from 30 mm to 70 mm, 40 mm to 60 mm, or 45 mm to 55 mm. In certain embodiments, a ratio of the expansion distance 218 to the length 214 and/or the width 216 may range between 1:1600 and 1:50. In certain embodiments, the one or more panels 80 may have a nominal volume (e.g., panel nominal volume), which can increase or decrease by at least equal to or greater than 5, 10, 20, 30, 40, 50, 60, 70, 80, 90, or 100 percent. In certain embodiments, the one or more panels 80 may be designed to vary in the length 214 and/or the width 216 (e.g., measured in a straight line) in response to the expansion or contraction (e.g., expansion distance 218) causing by the bowing of the sidewalls 168. In certain embodiments, the one or more panels 80 may be configured to flex inward and outward to change a nominal volume (e.g., combined volume of the heat exchanger 34 and the subsea station 12), such as by increasing or decreasing the nominal volume by at least equal to or greater than 1, 2, 3, 4, 5, 6, 7, 8, 9, or 10 percent.

In the illustrated embodiment, the one or more panels 80 may be spaced by a spacing dimension 220. In certain embodiments, the spacing dimension 220 may the one or more panels 80 may be more than 100 mm, 200 mm, 300 mm, 400 mm, 500 mm, 600 mm, 700 mm, 800 mm, or 900 mm. It may be appreciated that the spacing dimension 220 may provide access to an attachment of a remotely operated vehicle (ROV) for cleaning of marine growth.

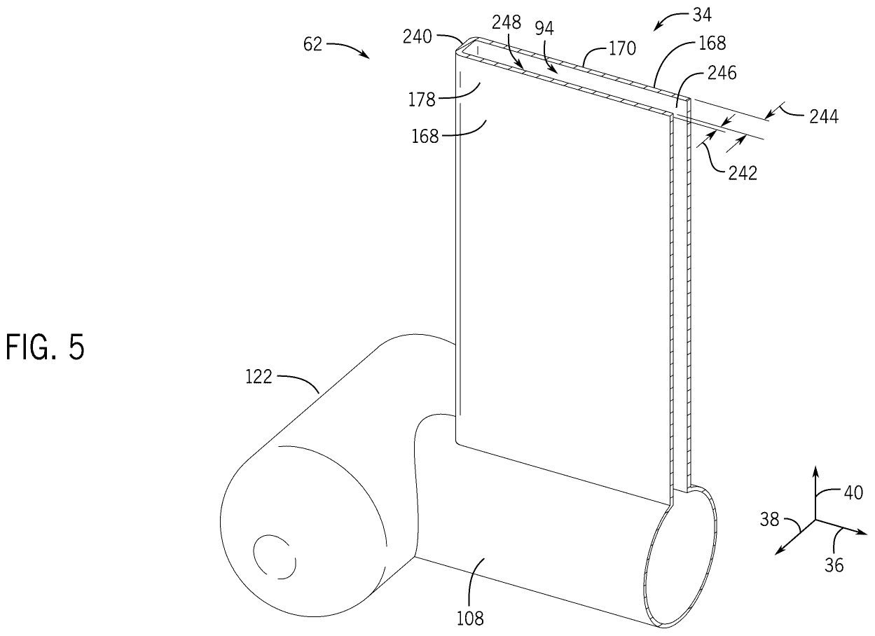

FIG. 5 is a partially cutaway perspective view of an embodiment of the heat exchanger 34 of FIG. 2 within an area identified by line 5-5. In the illustrated embodiment, the heat exchanger 34 includes a panel 80 of the heat exchanger system 62, the panel 80 having side walls 168 (e.g., inner side wall 170, outer side wall 178) separated by the channel 94. The inner side wall 170 and the outer side wall 178 are both coupled to a connecting wall 240. In certain embodiments, the inner side wall 170 and/or the outer side wall 178 may be welded to the connecting wall 240. As illustrated, the panel 80 at the connection of the walls 170, 178, and 240 has a substantially rectangular edge profile. As shown, the panel 80 is fluidly coupled to the converging conduit 108, which is fluidly coupled to the outlet conduit 122.

In the illustrated embodiment, the side walls 168 have a sidewall thickness 242. In certain embodiments, the sidewall thickness 242 of the side walls 168 is less than or equal to about 3 mm, 5 mm, 8 mm, 12 mm, 15 mm, 25 mm or 40 mm. In certain embodiments, the side wall thickness 242 is between 5 mm and 15 mm, 7 mm and 13 mm, or 9 mm and 11 mm. In certain embodiments, the side wall thickness 242 may vary in the vertical direction 40. For example, as shown in the illustrated embodiment, the side wall thickness 242 of the side walls 168 may be greater near the converging conduit 108.

In the illustrated embodiment, the channel 94 has a channel width 244, which spans from a first inner surface 246 of the inner side wall 170 to a second inner surface 248 of the outer side wall 178. In certain embodiments, the channel width 244 may be between 5 mm and 100 mm, 7 mm and 100 mm, 10 mm and 100 mm, 15 mm and 100 mm, 5 mm and 50 mm, 7 mm and 50 mm, between 10 mm and 50 mm apart, between 10 mm and 75 mm apart, or between 15 mm and 50 mm apart.

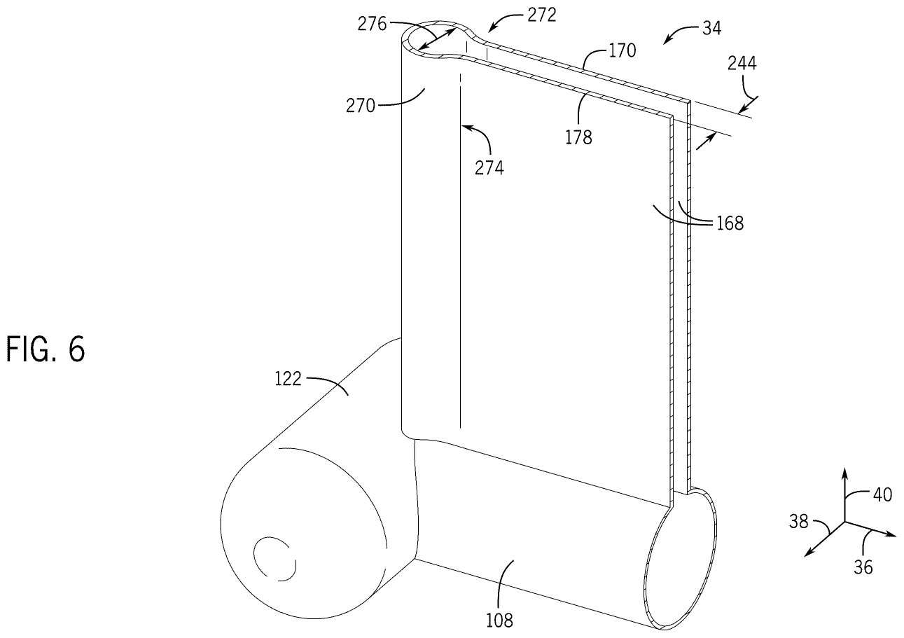

FIG. 6 is a partially cutaway perspective view of an embodiment of the heat exchanger 34 of FIG. 2 within an area identified by line 5-5 having a curved side wall 270 (e.g., curved connection wall, curved wall, curved edge profile, etc.). As shown, a first end 272 of the curved side wall 270 is coupled (e.g., welded) to the inner side wall 170, and a second end 274 of the curved side wall 270 is coupled to the outer side wall 178. In certain embodiments, a diameter 276 of the curved side wall 270 is greater than the channel width 244. As shown, the curved side wall 270 extends along the vertical direction 40 and is coupled to both the inner side wall 170 and the outer side wall 178 along the vertical direction 40. In certain embodiments, the curved side wall 270 may also be coupled (e.g., welded) to the diverging conduit, the converging conduit 108, and/or the outlet conduit 122.

In certain embodiments, the curved side wall 270 may be manufactured by cutting a section from a pipe along an axial direction of the pipe, such that the width of the section cut out of the pipe matches the channel width 244. It may be appreciated that the curved side wall 270 may reduce increase a radius of curvature between the side walls 168 and the connecting wall 240 of FIG. 5, thereby reducing an amount of stress imparted on the coupling (e.g., weld lines, weld joints, etc.) between the side walls 168 and the connecting wall 240.

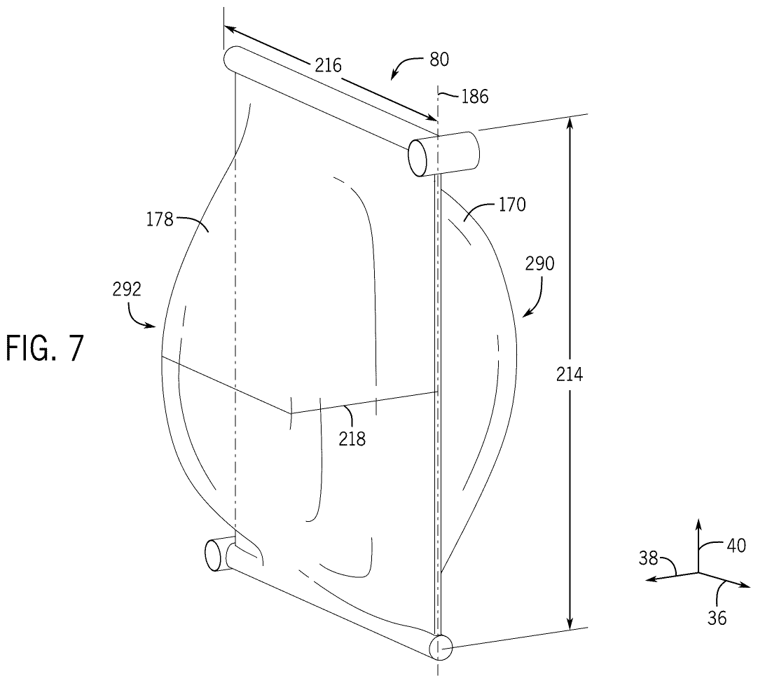

FIG. 7 is a perspective view of an embodiment of a panel 80 of the heat exchanger 34 of FIG. 2 in an expanded state. As discussed herein, the one or more panels 80 are configured to integrally expand in response to variations in the pressure, the temperature, or the combination thereof, of the insulating fluid 48 disposed in the heat exchanger 34. In the illustrated embodiment, an inner center portion 290 of the inner side wall 170 and an outer center portion 292 of the outer side wall 178 are expanded (e.g., bowed, bulged, curved, etc.) outward relative to the central axis 186 of the panel 80.

In the illustrated embodiment, the panel 80 has the length 214 and the width 216. The length 214 and/or the width 216 of the panel 80 may be greater than 1 meter, 2 meters, 3 meters, 4 meters, 5 meters, or 6 meters. In certain embodiments, the length 214 and/or the width 216 may range from 3 meters to 6 meters. As shown, the expansion distance 218 of the inner center portion 290 and the outer center portion 292 is outward relative to the central axis 186 (e.g., vertical axis, vertical central axis) of the panel 80. In certain embodiments, the expansion distance 218 may be more than 5 millimeters (mm), 10 mm, 20 mm, 40 mm, or 70 mm. In certain embodiments, the expansion distance 218 may range from 30 mm to 70 mm, 40 mm to 60 mm, or 45 mm to 55 mm. In certain embodiments, a ratio of the expansion distance 218 to the length 214 and/or the width 216 of the panel 80 may range from 1:1600 to 1:50. Additionally, in certain embodiments, the one or more panels 80 may have a nominal volume, which can increase or decrease by at least equal to or greater than 5, 10, 20, 30, 40, 50, 60, 70, 80, 90, or 100 percent to accommodate changes in volume of the insulating fluid 48.

In certain embodiments, the one or more panels 80 change from a substantially flat profile to a curved profile (e.g., concave or convex) in response to the changes in volume of the insulating fluid 48. In certain embodiments, the one or more panels 80 may expand into at least 50, 60, 70, 80, 90, 95, or 100 percent of a lateral spacing between the adjacent panels 80 when expanding to accommodate volume increases caused by increases in temperature, pressure, or a combination thereof, of the insulating fluid 48. Additionally, the one or more panels 80 may be configured to expand or contract the inner side wall 170 and the outer side wall 178 in a substantially smooth curved manner (e.g., gradual curvature without abrupt changes in angles). In some embodiments, the inner side wall 170 and the outer side wall 178 may further include foldable and unfoldable wall portions (e.g., zigzagging wall portions, bellows portions, etc.). However, in certain embodiments, such as illustrated in FIG. 7, the inner side wall 170 and the outer side wall 178 exclude such foldable and unfoldable wall portions.

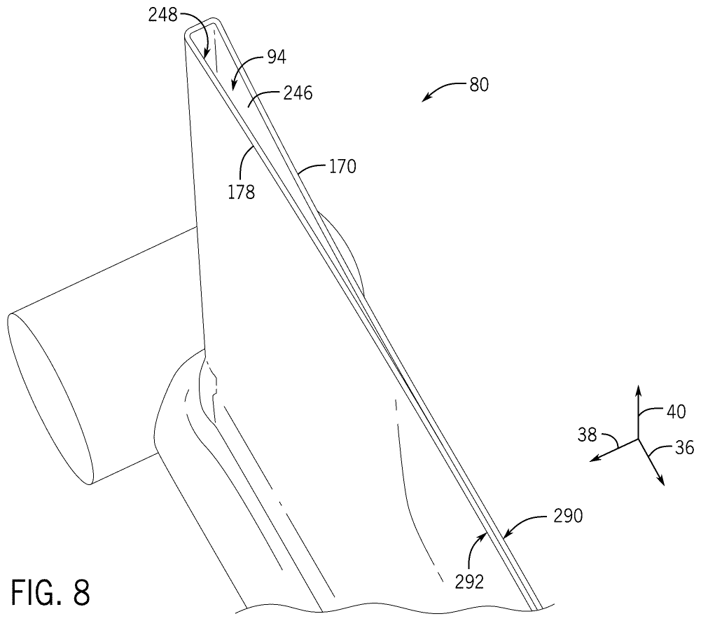

FIG. 8 is a partially cutaway perspective view of an embodiment of the panel 80 of FIG. 7 in a contracted state. In the illustrated embodiments, the inner side wall 170 and the outer side wall 178 are squeezed together such that the first inner surface 246 and the second inner surface 248 physically contact each other. As shown, the first inner surface 246 and the second inner surface 248 physically contact each other near the inner center portion 290 of the inner side wall 170 and the outer center portion 292 of the outer side wall 178. It may be appreciated that the inner side wall 170 and the outer side wall 178 may support each other in this manner when a vacuum is applied to the channel 94, or when the pressure of the water 60 exceeds the pressure of the insulating fluid 48 and causes contraction of the inner side wall 170 and the outer side wall 178.

As discussed herein, in certain embodiments, the panel 80 may include one or more support structures (e.g., internal supports, perforated supports) disposed in the channel 94 between the inner side wall 170 and the outer side wall 178. The one or more support structures may provide a separation between the first inner surface 246 and the second inner surface 248 such that the first inner surface 246 and the second inner surface 248 do not make contact when a vacuum is applied to the subsea station and/or the channel 94. In other words, the one or more support structures may be configured to limit or stop contraction of the inner side wall 170 and the outer side wall 178 toward one another to maintain a minimum gap or separation distance between the inner side wall 170 and the outer side wall 178.

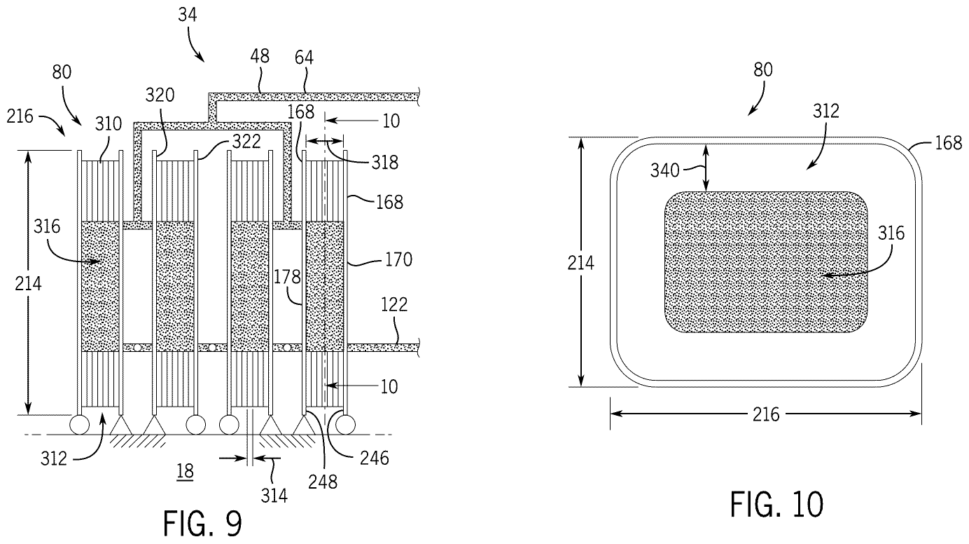

FIG. 9 is a side cross-sectional view of an embodiment of the one or more panels 80 of the heat exchanger 34 of FIG. 2 having expandable side walls 310 (e.g., corrugated walls, foldable side walls). As shown, the expandable side walls 310 include a plurality of plates 312 coupled (e.g., welded) together. The plurality of plates 312 may behave similarly to an accordion bellows, such that the expandable plates 312 expand (e.g., unfold) and/or contract (e.g., fold) in response to variations in the pressure, temperature, or the combination thereof of the insulating fluid 48. In certain embodiments, one or more of the expandable plates 312 may be composed of steel (e.g., stainless steel, cathodic protected carbon steel, etc.). Additionally or alternatively, the expandable plates 312 may have a thickness 314 of at least 3 mm, 4 mm, 5 mm, 6 mm, 7 mm, 8 mm, 9 mm, 12 mm, or 15 mm.

In the illustrated embodiment, the panels 80 include the expandable side walls 312 and the side walls 168. As shown, the expandable side walls 312 and the side walls 168 form enclosed chambers 316 within the panels 80. The enclosed chambers 316 have a chamber width 318 spanning from the first inner surface 246 of the inner side wall 170 and the second inner surface 248 of the outer side wall 178. In certain embodiments, the chamber width 318 may be between 0.2 meters (m) and 1.0 m, 0.2 m and 0.9 m, 0.2 m and 0.8 m, 0.2 m and 0.7 m, 0.2 m and 0.6 m, 0.25 m and 1.0 m, 0.3 m and 1.0 m, 0.25 m and 0.9 m, 0.3 m and 0.9 m, or 0.3 m and 0.8 m. As discussed herein, the length 214 and/or the width 216 of the one or more panels 80 may be greater than 1 meter, 2 meters, 3 meters, 4 meters, 5 meters, or 6 meters. In certain embodiments, the length 214 and/or the width 216 may range from 3 meters to 6 meters. In certain embodiments, a ratio between the chamber width 318 and the length 214 and/or the width 216 may range from 1:30 and 1:1.

In the illustrated embodiment, one of side walls 168 of each panel 80 is a stationary side wall 320 (e.g., anchored to the sea floor 18), while the other side wall 168 is a moving side wall 322. For example, the moving side wall 322 may be equipped with one or more wheels 324, such that the moving side wall 322 may translate relative to the stationary side wall 320, thereby providing volumetric expansion in response to a change (e.g., increase) in the pressure, the temperature, or both of the insulating fluid 48. In some embodiments, the one or more wheels 324 may roll along respective tracks in the direction of movement, thereby guiding the movement while the moving side wall 322 moves toward or away from the stationary side wall 320.

Colder fluid has higher density and sinks to the bottom while hotter fluid has lower density and gets updrift in a natural convection cooler. Thus, to further aid in cooling, the inlet conduit 64 for the insulating fluid 48 may be disposed as high as possible while the outlet conduit(s) 122 may be disposed as low as possible.

In certain embodiments, the expandable side walls 312 may also flex in response to thermal expansion of a dielectric fluid flowing through the internal fluid pipes; the dielectric fluid may change in temperature from cool ambient to hot under full power. For deep water applications, the fluid filling the internal fluid pipes may be adjusted to compensate for pressure compression of fluid. In certain embodiments, the one or more panels 80 have a combination of the features shown in FIGS. 1-9.

FIG. 10 is a side cross-sectional view of an embodiment of a panel 80 of FIG. 9 along line 10-10. As shown, the panel 80 includes the enclosed chamber 316 disposed within the panel 80, surrounded by the expandable side walls 312 and the side walls 168. In the illustrated embodiment, the expandable side walls 312 include a depth 340. In certain embodiments, the depth 340 of the expandable side walls 312 may be more than 0.1 m, 0.2 m, 0.4 m, 0.8 m, 1.2 m, 1.6 m, or 2 m. In certain embodiments a ratio between the depth 340 of the expandable side walls 312 and the length 214 and/or the width 216 of the panel 80 may fall within 1:80 to 1:3.

In the illustrated embodiment, the expandable side walls 312 and the enclosed chamber 316 both have a beveled rectangular shape. In certain embodiments, the expandable side walls 312 and/or the enclosed chamber 316 may be rectangular or circular in shape. For example, the expandable side walls 312 and/or the enclosed chamber 316 may be elliptical, oval, circular, or square in shape.

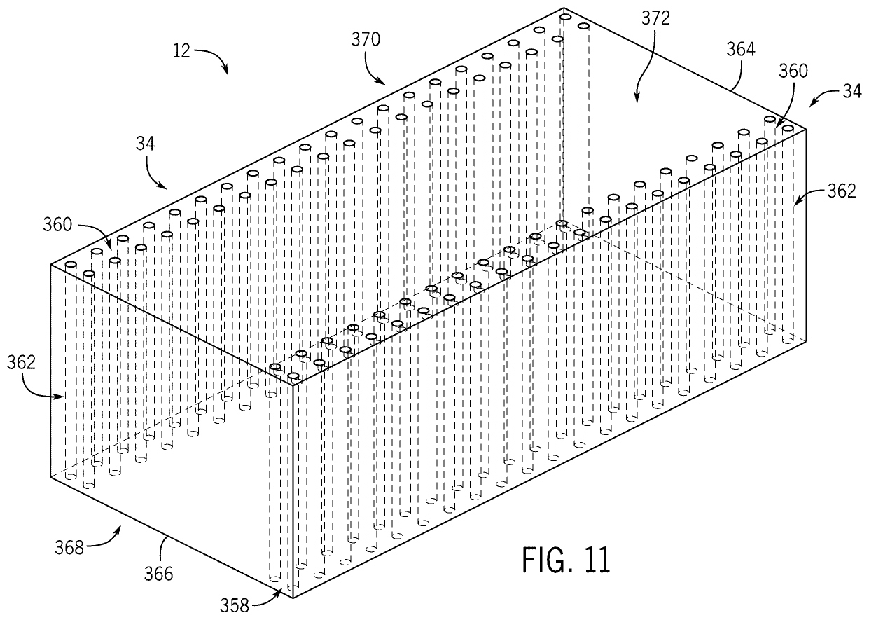

FIG. 11 is schematic perspective view of the subsea station 12 (e.g., subsea transformer station) and the heat exchanger 34. In the illustrated embodiment, the heat exchanger 34 is integrally coupled to an exterior portion 358 of the subsea station 12. As shown, the heat exchanger 34 includes the one or more walls 360 (e.g., panels) that form integral walls of the subsea station 12. The one or more walls 360 are flexible to compensate for the volumetric expansion of the insulating fluid disposed in the heat exchanger 34 in response to variations in the pressure, the temperature, or both of the insulating fluid. In certain embodiments, the walls 360 may be configured to flex inward and outward to change a nominal volume of a combined volume of the heat exchanger 34 and the subsea station 12, such as by increasing or decreasing the nominal volume by at least equal to or greater than 1, 2, 3, 4, 5, 6, 7, 8, 9, or 10 percent.

In the illustrated embodiment, the one or more walls 360 include a plurality of channels 362 (e.g., pipes) extending from a first side surface 364 of the walls 360 to a second side surface 366 of the walls 360. The plurality of channels 362 is disposed vertically along the walls 360 to enable fluid (e.g., water or seawater) to circulate and support the overall structural integrity of the subsea station 12. This structural integrity would be maintained during fabrication, vacuum filling, transportation, and installation of the transformer. It may be appreciated that the plurality of channels 362 support the walls 360 during the vacuum process when the walls 360 may deflect inward. To support the flexible walls 360 during the vacuum process, a dedicated surface with inherent strength to support the walls 360 may be used. For example, the channels 362 may be welded together with a plurality of stiffeners and dedicated flat areas to provide support for, while avoiding excess stress to, the walls 360.

In certain embodiments, the plurality of channels 362 enable fluid (e.g., water or seawater) to be warmed up affecting density in a way that provides additional buoyancy. This results from the natural circulation of water entering through a bottom side 368 of the subsea station 12 and exiting through a top side 370. While the present embodiment is shown with the plurality of channels 362 disposed in the walls 360 of the subsea station 12, in certain embodiments, the channels 362 may be disposed at other locations throughout the subsea structure 12 including disposed internally or toward a center area 372 of the subsea station 12. The channels 362 may be cleaned by a rotational or oscillating brush. In a subsea environment, these cleaning operations may be driven from a remotely operated vehicle (ROV), robot arm, or other actuator-based devices. In certain embodiments, the channels 362 may be arranged in a manner that would facilitate efficient cleaning of the channels using the ROV.

It may be recognized that the heat exchanger 34 may include a combination of the embodiments discussed herein. For example, the heat exchanger 34 may include the heat exchanger system 62 described in FIG. 2 in combination with the expandable side walls 310 described in FIG. 9 and/or the channels 362 disposed within the exterior portion 358 of the heat exchanger 34 described herein.

Technical effects of the disclose embodiments include usage of panels with thicker walls, which allow for simpler welding, non-destructive testing (NDT), and reduces risk of damage from external forces. Non-destructive testing may include, but is not limited to, ultrasonic testing, magnetic particle testing, eddy current testing, liquid penetrant testing, and radiographic testing. The radiators may be tested separately to verify fatigue resistance, cooling, and compensation volume. A standard qualified design may be scaled by adding more layers of radiators to accommodate cooling or compensation requirements. The use of cathodic protected carbon steel rather than expensive stainless may improve cooling and reduce cost. A mechanical stress analysis may further influence the geometry of the radiators. Additionally, the embodiments disclosed herein provide a system that provides both volumetric expansion of a fluid disposed in a subsea transformer station, as well as thermal energy diffusion. The combined functionality of volumetric expansion and heat diffusion may reduce costs and simplify the design of the system.

The subject matter described in detail above may be defined by one or more clauses, as set forth below.

According to a first aspect, a system includes a subsea transformer station and a heat exchanger fluidly coupled to the subsea transformer station. The heat exchanger is configured to diffuse thermal energy from the subsea transformer station. A portion of the heat exchanger is configured to receive a fluid from the subsea transformer station. The portion of the heat exchanger is also configured to expand, contract, or a combination thereof in response to variations of a pressure of the fluid, a temperature of the fluid, or a combination thereof.

The system of the preceding clause, wherein the heat exchanger includes an inlet conduit configured to receive the fluid from the subsea transformer station; an outlet conduit configured to return the fluid to the subsea transformer station; and an expandable panel comprising a channel enclosed in the expandable panel, wherein the channel is fluidly coupled to the inlet and the outlet.

The system of any preceding clause, wherein the expandable panel is configured to expand outward relative to a central axis of the expandable panel in response to variations in the pressure, the temperature, or the combination thereof; contract inward relative to the central axis in response to the variations in the pressure, the temperature, or the combination thereof; or a combination thereof.

The system of any preceding clause, wherein the expandable panel includes inner and outer walls; and one or more corrugated walls coupled to the inner and outer walls, wherein the one or more corrugated walls are configured to expand between the inner and outer walls in response to the variations in the pressure, the temperature, or the combination thereof.

The system of any preceding clause, wherein the expandable panel includes a first side wall configured to integrally bulge outward relative to the central axis in response to the variations in the pressure, the temperature, or the combination thereof; integrally contract inward relative to the central axis in response to the variations in the pressure, the temperature, or the combination thereof; or a combination thereof.

The system of any preceding clause, wherein the expandable panel includes a second side wall, wherein the first side wall, the second side wall, or both is configured to bulge at least 5 millimeters outward relative to the central axis in response to the variations in the pressure, the temperature, or the combination thereof.

The system of any preceding clause, wherein the first side wall is configured to curve relative to the central axis in response to the variations in the pressure, the temperature, or the combination thereof.

The system of any preceding clause, wherein a volume of the channel is configured to increase by at least 10 percent in response to the variations in the pressure, the temperature, or the combination thereof.

The system of any preceding clause, wherein the expandable panel includes a support structure disposed between the first and second side walls, wherein the support structure is configured to separate the first and second side walls in response to a vacuum applied to the channel.

The system of any preceding clause, wherein the expandable panel includes a curved wall, wherein a first end of the curved wall is coupled to the first side wall and a second end of the curved wall is coupled to the second side wall.

The system of any preceding clause, wherein the heat exchanger is integrally formed into an outer portion of the subsea transformer station, wherein the heat exchanger includes a channel extending from a first side surface of the heat exchanger to a second side surface of the heat exchanger; and an expandable wall configured to expand in response to an increase in the pressure, the temperature, or a combination thereof.

The system of any preceding clause, wherein the subsea transformer station includes one or more transformers, and the fluid includes an insulating oil.

According to a second aspect, a system includes a heat exchanger configured to fluidly couple to a subsea transformer station. The heat exchanger is also configured to diffuse thermal energy from the subsea transformer station. A portion of the heat exchanger is configured to at least partially expand, contract, or a combination thereof in response to variations of a pressure, a temperature, or a combination thereof of a fluid disposed within the subsea transformer station.

The system of the preceding clause, wherein the heat exchanger includes an inlet configured to receive the fluid from the subsea transformer station; an outlet configured to return the fluid to the subsea transformer station; and an expandable panel comprising a channel enclosed in the expandable panel, wherein the channel is fluidly coupled to the inlet and the outlet.

The system of any preceding clause, wherein the expandable panel is configured to expand outward relative to a central axis of the expandable panel in response to the variations in the pressure, the temperature, or the combination thereof; contract inward relative to the central axis in response to the variations in the pressure, the temperature, or the combination thereof; or a combination thereof.

The system of any preceding clause, wherein the expandable panel includes a side wall configured to integrally bulge outward relative to the central axis in response to the variations in the pressure, the temperature, or the combination thereof.

The system of any preceding clause, wherein the side wall is configured to bulge at least 5 millimeters outward relative to the central axis in response to the variations in the pressure, the temperature, or the combination thereof.

The system of any preceding clause, wherein a volume of the channel is configured to increase by at least 10 percent in response to the variations in the pressure, the temperature, or the combination thereof.

The system of any preceding clause, wherein the subsea transformer station includes one or more transformers, and the fluid comprises an insulating oil.

According to a third aspect, a method includes transferring a fluid from a subsea transformer station to a heat exchanger. The method also includes diffusing thermal energy from the fluid in response to the fluid flowing through the heat exchanger. The method also includes returning the fluid from the heat exchanger to the subsea transformer station. The method also includes expanding a portion of the heat exchanger in response to an increase in a pressure of the fluid.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a subsea transformer station; and
a heat exchanger fluidly coupled to the subsea transformer station;
wherein the heat exchanger is configured to diffuse thermal energy from the subsea transformer station;
wherein a portion of the heat exchanger is configured to:
receive a fluid from the subsea transformer station; and
expand, contract, or a combination thereof, in response to variations of a pressure of the fluid, a temperature of the fluid, or a combination thereof.

2. The system of claim 1, wherein the heat exchanger comprises:
an inlet conduit configured to receive the fluid from the subsea transformer station;
an outlet conduit configured to return the fluid to the subsea transformer station; and
an expandable panel comprising a channel enclosed in the expandable panel, wherein the channel is fluidly coupled to the inlet and the outlet.

3. The system of claim 2, wherein the expandable panel is configured to:
expand outward relative to a central axis of the expandable panel in response to variations in the pressure, the temperature, or the combination thereof;
contract inward relative to the central axis in response to the variations in the pressure, the temperature, or the combination thereof;
or a combination thereof.

4. The system of claim 3, wherein the expandable panel comprises:
inner and outer walls; and
one or more corrugated walls coupled to the inner and outer walls, wherein the one or more corrugated walls are configured to expand between the inner and outer walls in response to the variations in the pressure, the temperature, or the combination thereof.

5. The system of claim 3, wherein the expandable panel comprises a first side wall configured to:
integrally bulge outward relative to the central axis in response to the variations in the pressure, the temperature, or the combination thereof;
integrally contract inward relative to the central axis in response to the variations in the pressure, the temperature, or the combination thereof;
or a combination thereof.

6. The system of claim 5, wherein the expandable panel comprises a second side wall, wherein the first side wall, the second side wall, or both is configured to bulge at least 5 millimeters outward relative to the central axis in response to the variations in the pressure, the temperature, or the combination thereof.

7. The system of claim 5, wherein the first side wall is configured to curve relative to the central axis in response to the variations in the pressure, the temperature, or the combination thereof.

8. The system of claim 7, wherein a volume of the channel is configured to increase by at least 10 percent in response to the variations in the pressure, the temperature, or the combination thereof.

9. The system of claim 8, wherein the expandable panel comprises a support structure disposed between the first and second side walls, wherein the support structure is configured to separate the first and second side walls in response to a vacuum applied to the channel.

10. The system of claim 6, wherein the expandable panel comprises a curved wall, wherein a first end of the curved wall is coupled to the first side wall and a second end of the curved wall is coupled to the second side wall.

11. The system of claim 1, wherein the heat exchanger is integrally formed into an outer portion of the subsea transformer station, wherein the heat exchanger comprises:
a channel extending from a first side surface of the heat exchanger to a second side surface of the heat exchanger; and
an expandable wall configured to expand in response to an increase in the pressure, the temperature, or a combination thereof.

12. The system of claim 1, wherein the subsea transformer station comprises one or more transformers, and the fluid comprises an insulating oil.

13. A system, comprising:
a heat exchanger configured to:
fluidly couple to a subsea transformer station; and
diffuse thermal energy from the subsea transformer station;
wherein a portion of the heat exchanger is configured to at least partially expand, contract, or a combination thereof in response to variations of a pressure, a temperature, or a combination thereof of a fluid disposed within the subsea transformer station.

14. The system of claim 13, wherein the heat exchanger comprises:
an inlet configured to receive the fluid from the subsea transformer station;
an outlet configured to return the fluid to the subsea transformer station; and
an expandable panel comprising a channel enclosed in the expandable panel, wherein the channel is fluidly coupled to the inlet and the outlet.

15. The system of claim 14, wherein the expandable panel is configured to:
expand outward relative to a central axis of the expandable panel in response to the variations in the pressure, the temperature, or the combination thereof;
contract inward relative to the central axis in response to the variations in the pressure, the temperature, or the combination thereof;
or a combination thereof.

16. The system of claim 15, wherein the expandable panel comprises a side wall configured to integrally bulge outward relative to the central axis in response to the variations in the pressure, the temperature, or the combination thereof.

17. The system of claim 16, wherein the side wall is configured to bulge at least 5 millimeters outward relative to the central axis in response to the variations in the pressure, the temperature, or the combination thereof.

18. The system of claim 16, wherein a volume of the channel is configured to increase by at least 10 percent in response to the variations in the pressure, the temperature, or the combination thereof.

19. The system of claim 13, wherein the subsea transformer station comprises one or more transformers, and the fluid comprises an insulating oil.

20. A method, comprising:
transferring a fluid from a subsea transformer station to a heat exchanger;
diffusing thermal energy from the fluid in response to the fluid flowing through the heat exchanger;
returning the fluid from the heat exchanger to the subsea transformer station; and
expanding a portion of the heat exchanger in response to an increase in a pressure of the fluid.
